(19) United States
(12) Patent Application Publication
(10) Pub. No.: US 2013/0028737 A1
(43) Pub. Date: Jan. 31, 2013

(54) Adjustable wind turbine generating device

(71) Applicant: Hai Pin Kuo, Tainan (TW)

(72) Inventor: Hai Pin Kuo, Tainan (TW)

(73) Assignee: Sports Art Industrial Co., Ltd.

(21) Appl. No.: 13/136,201

(22) Filed: Jul. 25, 2011

(51) Int. Cl. F03D 3/06

(52) U.S. Cl. 416/17

(57) ABSTRACT

A wind turbine includes a nacelle supported on top of a tower and having a chamber for receiving a coil, a spindle rotatably and slidably engaged in the nacelle and having one end extendible out of the nacelle, a rotator blade device mounted onto the spindle, a rotor attached to the spindle and movable relative to the coil, and a spring biasing member for moving the rotor relative to the coil, and the rotator blade device is movable toward the nacelle with a head wind, and the rotor is movable relative to the coil to adjust a torque between the coil and the rotor when the spindle and the rotor are moved relative to the coil with the rotator blade device, and the rotator blade device is movable away from the nacelle with the spring biasing member.

### BACKGROUND OF THE INVENTION

1. Field of the Invention

The present invention relates to a wind turbine, and more particularly to an adjustable wind turbine generating arrangement or device or mechanism for allowing the wind turbine device to be easily driven or actuated or operated at the beginning or with the lower head wind and for allowing the wind turbine to be driven or actuated or operated to generate a relatively greater electric power when heading a greater head wind.

2. Description of the Prior Art

Typical wind turbines comprise a nacelle pivotally or rotatably supported on top of a tower, and one or more rotator blades pivotally or rotatably attached or mounted or secured onto the tower and connected or coupled to the motor or the generator for rotating or driving or actuating the motor or generator to generate an electric energy or power.

For example, U.S. Patent No. 6,703,718 to Calley et al. discloses one of the typical wind turbines comprising a permanent magnet alternator that uses a boost mode controller to improve performance at low and high wind speeds, and to allow the permanent magnet alternator to be slowed so that the wind turbine can be stall controlled.

However, a complicated structure or arrangement and a number of electric parts or elements are required to be provided to control and to improve the performance of the permanent magnet alternator of the typical wind turbines at low and high wind speeds, normally, the rotors of the typical wind turbines may not be moved or adjusted axially.

The present invention has arisen to mitigate and/or obviate the afore-described disadvantages of the conventional gale protections for the wind turbines.

### SUMMARY OF THE INVENTION

The primary objective of the present invention is to provide an adjustable wind turbine generating arrangement or device or mechanism arranged for allowing the wind turbine device to be easily driven or actuated or operated at the beginning or with the lower head wind and for allowing the wind turbine to be driven or actuated or operated to generate a relatively greater electric power when heading a greater head wind.

In accordance with one aspect of the invention, there is provided a wind turbine comprising a nacelle including a chamber formed therein, a coil disposed in the chamber of the nacelle and including a compartment formed therein and defined by an inner peripheral surface, a spindle rotatably received and engaged in the chamber of the nacelle and including a first end extendible out of the nacelle, and including a second end, the spindle being slidable relative to the nacelle, a rotator blade device mounted onto the first end of the spindle for rotating the spindle relative to the coil to generate an electric energy, a rotor attached to the spindle and rotated in concert with the spindle, and movable relative to the coil, and a spring biasing member for biasing and moving the rotor to move relative to the coil, and to move the rotator blade device away from the nacelle, and the rotator blade device is movable toward the nacelle with a head wind, and the rotor is movable relative to the coil to adjust a torque between the coil and the rotor when the spindle and the rotor are moved axially relative to the coil and the nacelle, and the rotator blade device being movable away from the nacelle with the spring biasing member when no head wind is directed toward the rotator blade device for allowing the wind turbine device to be easily driven at the beginning or with the lower head wind.

The spindle is rotatably received and engaged in the chamber of the nacelle with at least one joint or journal bearing. The spring biasing member is engaged with the joint or journal bearing for biasing and moving the rotor and the spindle to move relative to the coil.

The inner peripheral surface of the coil is an inclined inner peripheral surface, and the coil includes a relatively greater inner diameter at a first end thereof and a relatively smaller inner diameter at a second end thereof for receiving the spindle.

The rotor includes a first end having a relatively greater outer diameter, and a second end having a relatively smaller outer diameter for forming an inclined outer peripheral surface which includes an inclination equal to that of the inclined inner peripheral surface of the coil for allowing the outer peripheral surface of the rotor to be moved and adjusted toward and away from the inner peripheral surface of the coil.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a wind turbine in accordance with the present invention;

FIG. 2 is a partial cross sectional view of the adjustable wind turbine generating arrangement or device or mechanism for the wind turbine;

FIG. 3 is another partial cross sectional view similar to FIG. 2, illustrating the operation of the adjustable wind turbine generating arrangement or device or mechanism of the wind turbine;

FIG. 4 is a further partial cross sectional view similar to FIGS. 2 and 3, illustrating the other arrangement of the adjustable wind turbine generating arrangement or device or mechanism of the wind turbine; and

FIG. 5 is a still further partial cross sectional view similar to FIG. 4, illustrating the actuation or operation of the adjustable wind turbine generating arrangement or device or mechanism of the wind turbine as shown in FIG. 4.

### DETAILED DESCRIPTION OF THE PREFERRED EMBODIMENT

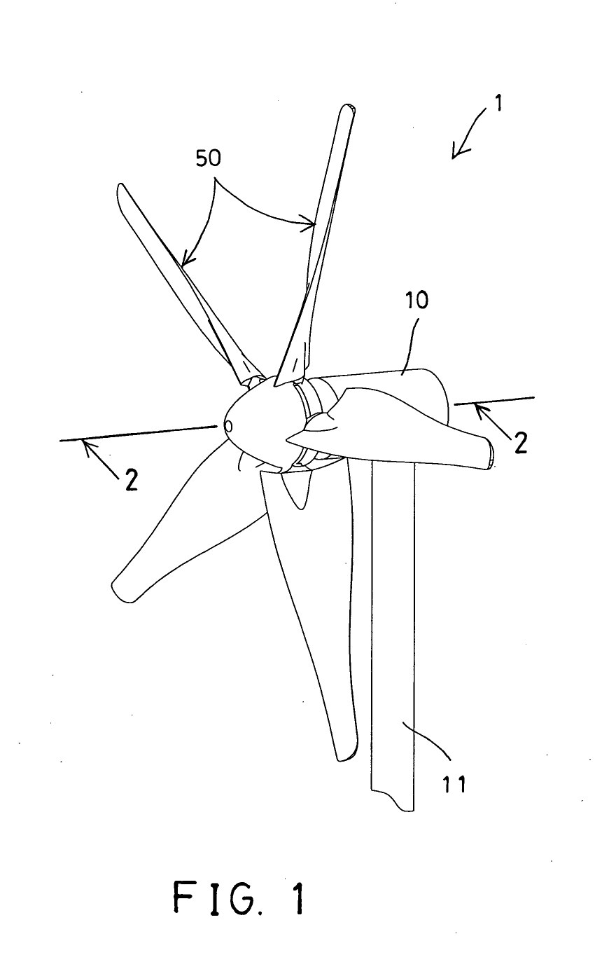

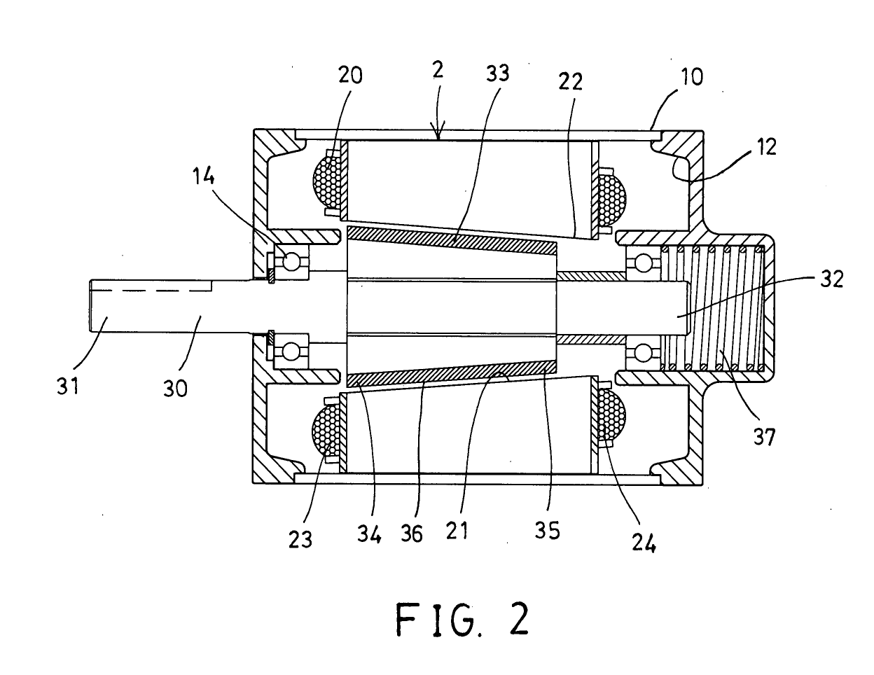

Referring to the drawings, and initially to FIGS. 1 and 2, a wind turbine 1 in accordance with the present invention comprises a mounting tube or housing or nacelle 10 attached or mounted or secured or supported on top of a tower 11 and including a chamber 12 formed therein for receiving or accommodating a motor or electric generator or generating arrangement or mechanism or device 2 which includes a coil 20 disposed or attached or mounted or secured or engaged in the nacelle 10, and a shaft or spindle 30 pivotally or rotatably and slidably attached or mounted or secured or supported in the chamber 12 of the nacelle 10 with one or more joints or journal bearings 14 and disposed or arranged or engaged in the coil 20.

The wind turbine 1 further includes one or more rotator blades or a rotator blade device 50 attached or mounted or secured onto the nacelle 10 and/or connected or coupled to the spindle 30 of the motor or electric generator or generating arrangement or mechanism or device 2 for rotating or driving or actuating the spindle 30 relative to the coil 20 of the motor or generator or generating arrangement or mechanism or device 2 to generate an electric energy or power. The above-described structure or configuration including the nacelle 10, and the rotator blade device 50 is typical and will not be described in further details.

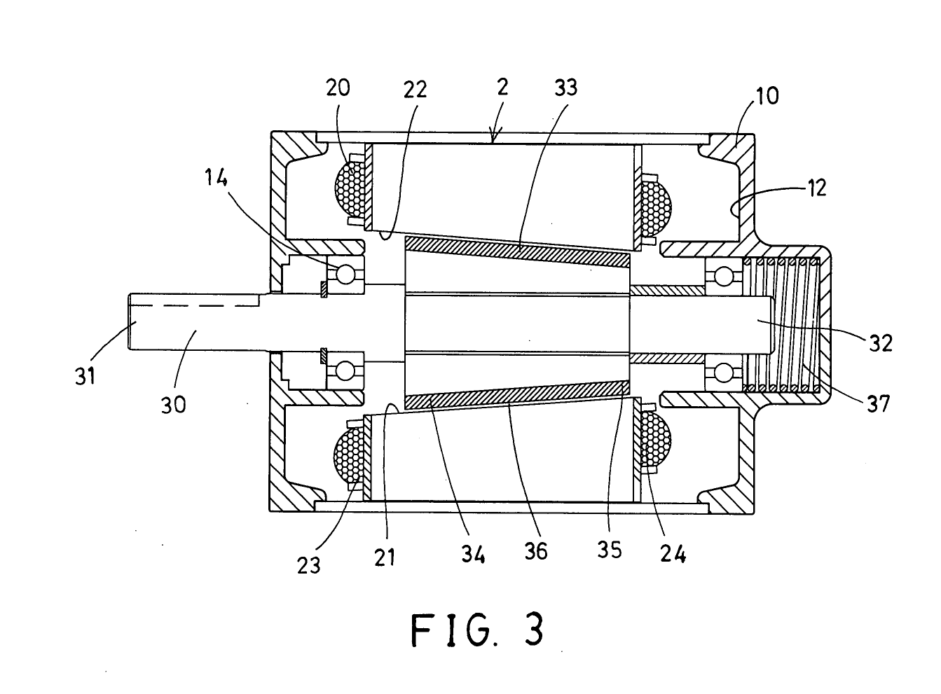

As shown in FIGS. 2 and 3, the coil 20 includes a compartment 21 formed therein, and formed or defined by a tiled or inclined inner peripheral surface 22, and includes a relatively greater inner diameter at one or first end 23 thereof and a relatively smaller inner diameter at the other or second end 24 thereof for receiving or accommodating the spindle 30 of the electric generating device 2. The spindle 30 includes one or first end 31 located or arranged or extended out of the nacelle 10 for attaching or mounting or securing or supporting the rotator blade device 50, and includes the other or second end 32 located or arranged or disposed or engaged in the nacelle 10.

The wind turbine 1 further includes a magnet or magnetic member or rotor 33 attached or mounted or secured on the spindle 30 and rotated in concert with the spindle 30, and movable relative to the coil 20, and includes a cone or frustum-shaped structure having a relatively greater outer diameter at one or first end 34 thereof and a relatively smaller outer diameter at the other or second end 35 thereof for forming or defining a tiled or inclined outer peripheral surface 36 which includes a tilt or inclination similar or equal to that of the tiled or inclined inner peripheral surface 22 of the coil 20, for allowing the outer peripheral surface 36 of the rotor 33 to be moved or adjusted toward or away from the inner peripheral surface 22 of the coil 20, and/or for allowing the rotor 33 to move relative to the coil 20 and to adjust the force or the torque between the coil 20 and the rotor 33 when the spindle 30 and the rotor 33 are moved axially relative to the coil 20 and the nacelle 10 (FIGS. 2, 3).

A spring biasing member 37 is disposed or engaged in the chamber 12 of the nacelle 10 and engaged between the nacelle 10 and one of the joints or journal bearings 14 and/or the spindle 30 and/or the rotor 33 for forcing or biasing the rotor 33 toward the one or first end 23 of the coil 20 (FIG. 2), and for moving the rotor 33 and the spindle 30 relative to the coil 20, and/or for forcing or biasing the one or first end 31 of the spindle 30 out of the nacelle 10, and/or for forcing or biasing or moving the rotator blade device 50 away from the nacelle 10. It is to be noted that the rotator blade device 50 may be forced to move toward the nacelle 10 by the head wind, and the spindle 30 may then be forced to move into the nacelle 10, and the rotor 33 may then be forced to move toward the other or second end 24 of the coil 20 (FIG. 3), and the outer peripheral surface 36 of the rotor 33 may then be moved or adjusted toward the inner peripheral surface 22 of the coil 20.

In operation, as shown in FIG. 2, when no head wind, or when heading a relatively slower wind or a steady wind, or when the head wind is relatively slower than a predetermined value, or when the head wind is not good enough to force and to move the spindle 30 into the nacelle 10, or when the head wind is relatively smaller than the resilience of the spring biasing member 37, the spring biasing member 37 may bias and force and move the one or first end 31 of the spindle 30 out of the nacelle 10, and the outer peripheral surface 36 of the rotor 33 may be forced and moved away from the inner peripheral surface 22 of the coil 20, such that the force or the torque of the coil 20 applied onto the rotor 33 and the spindle 30 is relatively smaller, and such that the rotor 33 and the spindle 30 and the rotator blade device 50 may be easily rotated or driven by the relatively slower head wind with a relatively smaller driving torque.

As shown in FIG. 3, when the rotator blade device 50 is forced to move toward the nacelle 10 by the relatively faster or stronger head wind, the spindle 30 may be forced to move into the nacelle 10 and to move onto the spring biasing member 37, and the rotor 33 may be forced to move toward the other or second end 24 of the coil 20, and the outer peripheral surface 36 of the rotor 33 may be moved or adjusted toward or closer to the inner peripheral surface 22 of the coil 20, such that the force or the torque of the rotor 33 and the spindle 30 applied onto the coil 20 is relatively greater or stronger and such that a relatively greater electric power or energy may be generated by the electric generating device 2. It is to be noted that the spring biasing member 37 may also be directly contacted or engaged with the other or second end 32 of the spindle 30 for biasing or forcing the one or first end 31 of the spindle 30 out of the nacelle 10, and/or for biasing or forcing or moving the rotator blade device 50 away from the nacelle 10.

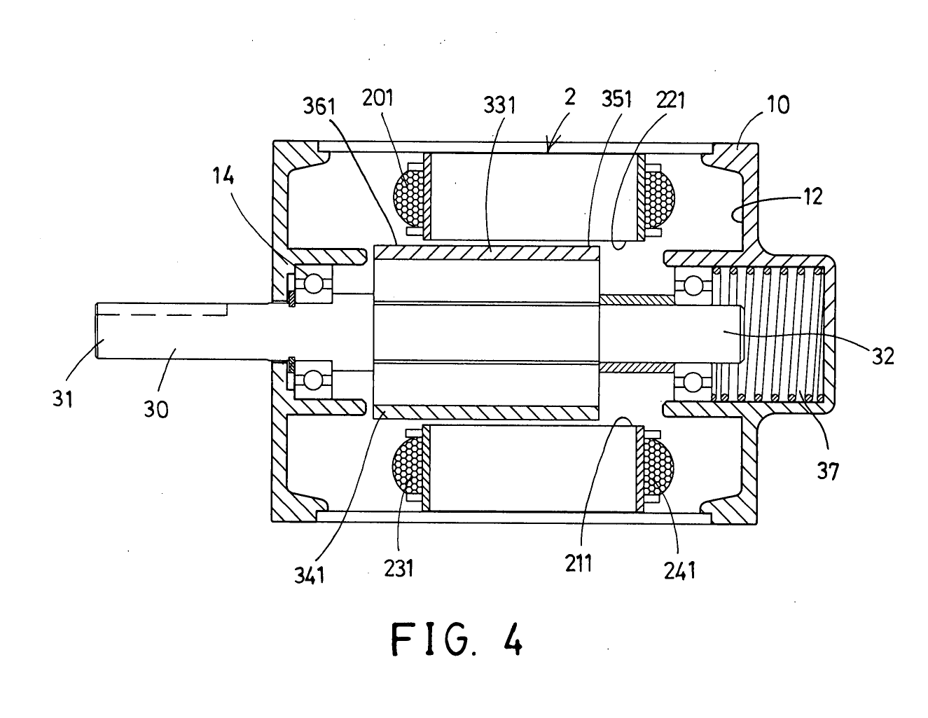

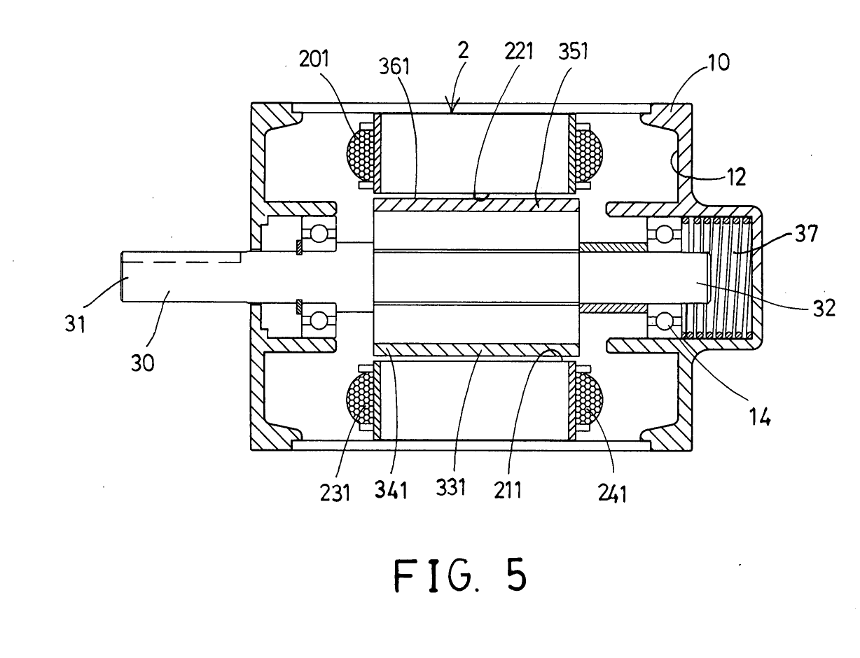

Alternatively, as shown in FIGS. 4 and 5, the compartment 211 of the coil 201 may includes a uniform and cylindrical structure formed or defined by a cylindrical inner peripheral surface 221, and includes an equal inner diameter at both the one or first end 231 thereof and the other or second end 241 thereof for receiving or accommodating the spindle 30 of the electric generating device 2, and the rotor 331 also includes a uniform and cylindrical structure formed or defined by a cylindrical outer peripheral surface 361, and includes an equal outer diameter at both the one or first end 341 thereof and the other or second end 351 thereof.

In operation, as shown in FIG. 4, when no head wind, or when heading a relatively slower wind or a steady wind, or when the head wind is relatively slower than a predetermined value, or when the head wind is not good enough to force and to move the spindle 30 into the nacelle 10, or when the head wind is relatively smaller than the resilience of the spring biasing member 37, the spring biasing member 37 may bias and force and move the one or first end 31 of the spindle 30 out of the nacelle 10, and the one or first end 341 of the rotor 331 may be forced and moved out of the coil 201, such that the force or the torque of the coil 201 applied onto the rotor 331 and the spindle 30 is relatively smaller, and such that the rotor 331 and the spindle 30 and the rotator blade device 50 may be easily rotated or driven by the relatively slower head wind with a relatively smaller driving torque.

As shown in FIG. 5, when the rotator blade device 50 is forced to move toward the nacelle 10 by the relatively faster or stronger head wind, the spindle 30 may be forced to move into the nacelle 10, and the rotor 331 may be forced to move toward the other or second end 241 of the coil 201, and the one or first end 341 of the rotor 331 may be moved into the compartment 211 of the coil 201, and/or for allowing the rotor 331 to move relative to the coil 201 and to adjust the force or the torque between the coil 201 and the rotor 331 such that the force or the torque of the rotor 331 and the spindle 30 applied onto the coil 201 is relatively greater or stronger and such that a relatively greater electric power or energy may be generated by the electric generating device 2.

Accordingly, the wind turbine in accordance with the present invention includes adjustable wind turbine generating arrangement or device or mechanism arranged for allowing the wind turbine device to be easily driven or actuated or operated at the beginning or with the lower head wind and for allowing the wind turbine to be driven or actuated or operated to generate a relatively greater electric power when heading a greater head wind.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wind turbine comprising:
a nacelle including a chamber formed therein,
a coil disposed in said chamber of said nacelle and including a compartment formed therein and defined by an inner peripheral surface,
a spindle rotatably received and engaged in said chamber of said nacelle and including a first end extendible out of said nacelle, and including a second end, said spindle being slidable relative to said nacelle,
a rotator blade device mounted onto said first end of said spindle for rotating said spindle relative to said coil to generate an electric energy,
a rotor attached to said spindle and rotated in concert with said spindle, and movable relative to said coil, and
a spring biasing member for biasing and moving said rotor to move relative to said coil, and to move said rotator blade device away from said nacelle, and
said rotator blade device being movable toward said nacelle with a head wind, and said rotor being movable relative to said coil to adjust a torque between said coil and said rotor when said spindle and said rotor are moved axially relative to said coil and said nacelle, and said rotator blade device being movable away from said nacelle with said spring biasing member when no head wind is directed toward said rotator blade device.

2. The wind turbine as claimed in claim 1, wherein said spindle is rotatably received and engaged in said chamber of said nacelle with at least one journal bearing.

3. The wind turbine as claimed in claim 2, wherein said spring biasing member is engaged with said at least one journal bearing for biasing and moving said rotor and said spindle to move relative to said coil.

4. The wind turbine as claimed in claim 1, wherein said inner peripheral surface of said coil is an inclined inner peripheral surface, and said coil includes a relatively greater inner diameter at a first end thereof and a relatively smaller inner diameter at a second end thereof for receiving the spindle.

5. The wind turbine as claimed in claim 4, wherein said rotor includes a first end having a relatively greater outer diameter, and a second end having a relatively smaller outer diameter for forming an inclined outer peripheral surface which includes an inclination equal to that of said inclined inner peripheral surface of said coil for allowing said outer peripheral surface of said rotor to be moved and adjusted toward and away from said inner peripheral surface of said coil.
